(19) United States
(12) Patent Application Publication
(10) Pub. No.: US 2015/0164004 A1
(43) Pub. Date: Jun. 18, 2015

(54) AGRICULTURAL HOUSE

(71) Applicant: PANASONIC INTELLECTUAL PROPERTY MANAGEMENT CO., LTD., Osaka (JP)

(72) Inventors: Naofumi Kodama, Shiga (JP); Takayoshi Tanizawa, Osaka (JP); Ikumasa Kishizoe, Chiba (JP)

(73) Assignee: PANASONIC INTELLECTUAL PROPERTY MANAGEMENT CO., LTD., Osaka (JP)

(21) Appl. No.: 14/413,065

(22) PCT Filed: Jun. 26, 2013
(86) PCT No.: PCT/JP2013/003982

§ 371 Date: Jan. 6, 2015

(30) Foreign Application Priority Data
Aug. 23, 2012 (JP) 2012-184427
Mar. 14, 2013 (JP) 2013-052311

(51) Int. Cl. A01G 9/14

(52) U.S. Cl. CPC A01G 9/14

(57) ABSTRACT

An agricultural greenhouse includes a house body and a curtain arranged along a roof inside the house body. The curtain is supported by a support part extended in the depth direction (Y-axis direction) of the house body and is configured be opened and closed in the depth direction along the support part. One end in the depth direction is a fixed end, and the other end is a free end. The curtain is opened and closed in the depth direction along the support part by fixing the fixed end at a regular position and moving the free end in the depth direction with movement of a pulley moving on the support part. Therefore, the curtain is in full-opened state when the free end is closest to the fixed end, and is in full-closed state when the free end is farthest away from the fixed end.

### TECHNICAL FIELD

The present invention relates to an agricultural house used for cultivation of agricultural products.

### BACKGROUND ART

Generally, this kind of agricultural house (vinyl house) realizes environment that is suitable for cultivation of agricultural products and different from the external world by maintaining indoor atmospheric temperature, indoor humidity, and the like (see Document 1: JP 8-70718 A). The agricultural house described in Document 1 includes a curtain (for example, resin film), which is openable and closable, to keep temperature and humidity in a house constant.

An opening/closing apparatus (for ventilator) is used for this agricultural house. The opening/closing apparatus includes a DC motor that has a rotation shaft. The rotation shaft is directly connected to an end of a winding shaft that is fixed to an end of the curtain. This opening/closing apparatus includes a supporting arm. The supporting arm has a lower end, which is fixed to a support base installed at a position close to an inner side of the house, and an upper end, which is connected to the motor. This supporting arm is expanded and contracted according to contacting of the motor on structural materials of the house while the motor rotates the winding shaft and rolls the curtain.

An agricultural house (green house) described in Document 2 (JP 2010-268734 A) includes a ceiling curtain that is openable and closable for dividing an upper space and improving a heat insulation effect. In this agricultural house, an upper end part of a left-hand side support is connected to an upper end part of a right-hand side support with a roof. Two or more curtains that constitute the ceiling curtain are opened and closed by moving along the roof in the transverse direction of a ridge (direction in which the left-hand side support and the right-hand side support oppose to each other).

Incidentally, in the agricultural house described in Document 1, the motor is displaced upwards the structural materials of the house while opening the curtain by rolling the curtain that covers the upper surface of the house from an end with the winding shaft, and displacing the winded end upward. Therefore, in this agricultural house, the curtain is displaced near a top part of the roof of the house from the lower end with the winding shaft when being full-opened. Also, in the agricultural house described in Document 2, the curtains is displaced near a top part of the roof or near a connecting part that is connected to the support in the roof when being full-opened.

Therefore, in these agricultural houses, even if it is the time at which the curtains are full-opened, the curtains are positioned at places that interrupt the solar radiation into the house. For this reason, there is possibility that intensity of radiation is deteriorated by the curtain and growing of agricultural products is affected.

### SUMMARY OF INVENTION

In view of the above-mentioned reason, the object of the present invention is to provide an agricultural house that can suppress deterioration of intensity of radiation with a curtain in a full-opened state.

The agricultural house according to a first aspect of the present invention includes a house body and a curtain. In the house body, a pair of side walls that oppose to each other and a roof connecting upper ends of the pair of side walls are extended in a depth direction. The curtain is provided along the roof inside the house body. The curtain is supported by at least one supporting part that is extended in the depth direction. The curtain is configured to be opened and closed along the depth direction.

According to this aspect, a curtain is supported by the supporting part extended in the depth direction of the house body, and is configured to be opened and closed along a supporting part in the depth direction. Therefore, there is an advantage that deterioration of intensity of radiation with the curtain of a full-opened state can be suppressed.

In the agricultural house of a second aspect of the present invention according to the first aspect, the house body includes a beam. The beam is arranged at both end parts in the depth direction along a plane orthogonal to the depth direction. The beam is configured to support the roof at least. The supporting part is fixed to the beam.

In the agricultural house of a third aspect of the present invention according to the first aspect or the second aspect, the at least one supporting part includes three or more supporting parts that are arranged in a width direction that is an opposite direction of the pair of side walls. The three or more supporting parts have different heights in positions at which the three or more supporting parts supports the curtain according to distances from the side walls so that the heights of the curtain is higher as the three or more supporting parts are farthest from the side walls.

In the agricultural house of a fourth aspect of the present invention according to the third aspect, the supporting part is arranged above the curtain. The supporting part is configured to support the curtain by hanging the curtain.

In the agricultural house of a fifth aspect of the present invention according to the fourth aspect, a pair of supporting parts that are placed at both ends in the width direction among the three or more supporting parts hangs each part between a central part and both end parts of the curtain in the width direction.

In the agricultural house of a sixth aspect of the present invention according to the fifth aspect, the pair of supporting parts hang each part closer to the both end parts than the central part of the curtain in the width direction.

In the agricultural house of a seventh aspect of the present invention according to the fifth aspect or the sixth aspect, the curtain is provided with a linear member. The linear member is extended in the depth direction. The linear member is arranged at each position on sides of the side walls. Each position is below than the pair of supporting parts. The curtain has both end parts in the width direction, which are hung on the linear member.

In the agricultural house of an eighth aspect of the present invention according to the seventh aspect, the curtain is provided with a fastener. The fastener is configured to surround the linear member. The fastener is attached at the both end parts of the curtain in the width direction.

In the agricultural house of a ninth aspect of the present invention according to any one of the first to eighth aspects, the agricultural further includes a sensor, an opening/closing apparatus, and a control part. The sensor is installed inside the house body. The sensor is configured to detect environment information including temperature at least. The opening/closing apparatus is configured to open and close the curtain. The control part is configured to control the opening/closing apparatus so that the curtain is opened and closed automatically according to a detection result of the sensor.

In the agricultural house of a tenth aspect of the present invention according to any one of the first to ninth aspects, the curtain includes a core material in each end part in the depth direction. The core material is configured to connect between both ends in the opposite direction of the pair of side walls at least. The curtain is configured to be opened and closed by the core material moving along the supporting part in the depth direction.

In the agricultural house of an eleventh aspect of the present invention according to any one of the first to tenth aspects, the agricultural house further includes an opening/closing apparatus. The opening/closing apparatus is configured to open and close the curtain. The opening/closing apparatus includes a rotating drum, a first pulley, and a second pulley. The rotating drum is configured, by winding a string combined with a free end that is an end of the curtain in the depth direction, to move the free end in the depth direction. In the first pulley, the string is hung between the rotating drum and the free end. In the second pulley, the string is hung between the rotating drum and the first pulley. The rotating drum and the first pulley are arranged along the roof. The second pulley is arranged below the rotating drum and the first pulley.

In the agricultural house of a twelfth aspect of the present invention according to the eleventh aspect, the rotating drum and the first pulley are provided with a fence. The fence is provided below the rotating drum and the first pulley so as to surround a circumference of the second pulley and the string. The second pulley is fixed to the fence.

In the agricultural house of a thirteenth aspect of the present invention according to any one of the first to twelfth aspects, the curtain includes a plurality of reinforcing bands. The reinforcing bands have strength more than other parts. The reinforcing bands are extended over both ends in the opposite direction of the pair of side walls. The curtain is supported by the supporting part at the reinforcing bands. The plurality of reinforcing bands are provided at predetermined intervals in the depth direction.

### BRIEF DESCRIPTION OF DRAWINGS

FIG. 1A is a front view of an agricultural house according to a first embodiment, and FIG. 1B is an upper face view of the agricultural house according to the first embodiment;

FIG. 2 is a perspective view of the agricultural house according to the first embodiment;

FIG. 3A is a front view of a main part of the agricultural house according to the first embodiment, and FIG. 3B is a side view of the main part of the agricultural house according to the first embodiment;

FIG. 4 is a schematic configuration diagram of an opening/closing apparatus of the agricultural house according to the first embodiment;

FIG. 5 is a front view of the main part of the agricultural house according to the first embodiment;

FIG. 6 is an explanatory view illustrating an operation of a folding mechanism of the agricultural house according to the first embodiment;

FIG. 7 is a block diagram showing a composition of a modification of the agricultural house according to the first embodiment;

FIG. 8 is a perspective view of an agricultural house according to a second embodiment;

FIG. 9 is a schematic configuration diagram of an opening/closing apparatus of an agricultural house according to a third embodiment;

FIG. 10A is a front view of a main part of the agricultural house according to the third embodiment, and FIG. 10B is a side view of the main part of the agricultural house according to the third embodiment; and

FIG. 11 is a front view of the main part of the agricultural house according to the third embodiment.

### DESCRIPTION OF EMBODIMENTS

In each of the following embodiments, an agricultural house will be described. The agricultural house includes a house body and a curtain provided along a roof inside the house body. The agricultural house is configured to realize environment that is suitable for cultivation of agricultural products and different from an external world by maintaining indoor atmospheric temperature, indoor humidity, and the like. Hereinafter, although the agricultural house mainly used for cultivation of delicate vegetables (such as spinach and komatsuna) will be described as an example, the use of the agricultural house is not limited to above.

### First Embodiment

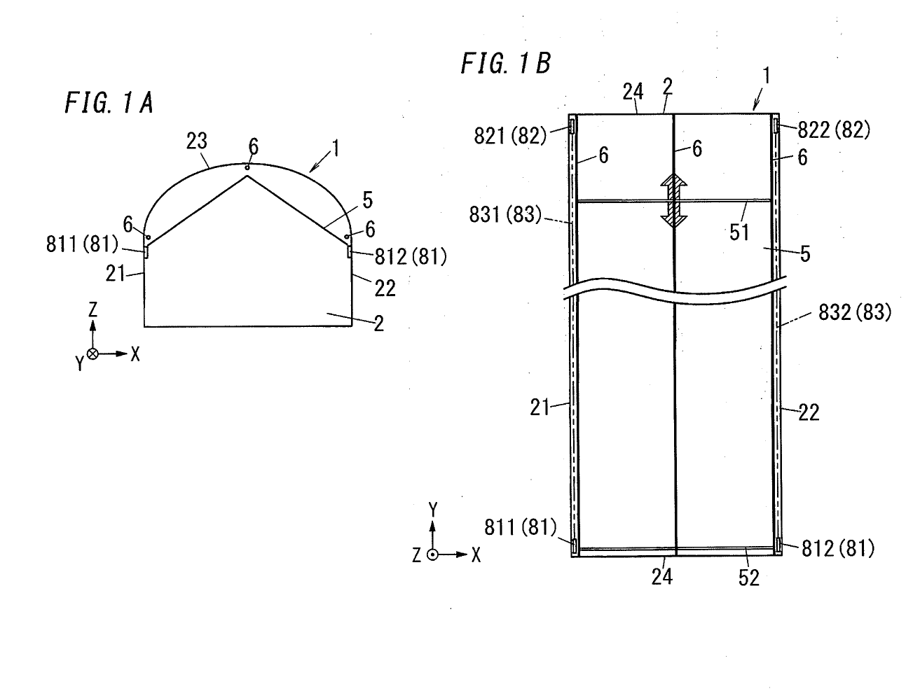

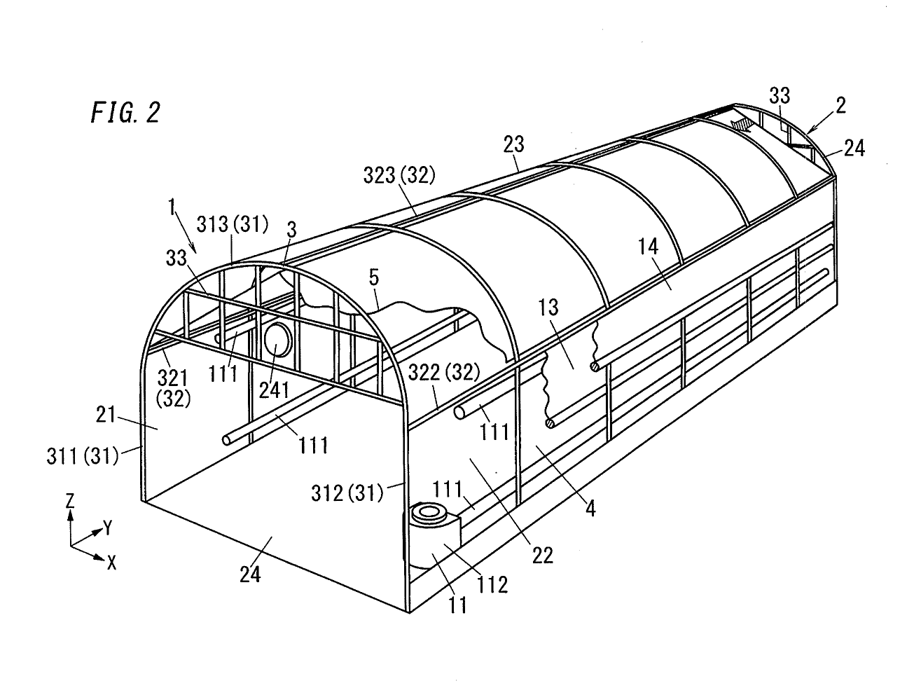

As shown in FIG. 2, an agricultural house 1 according to the present embodiment includes a house body 2 and a curtain 5. The house body 2 is configured so that a pair of side walls 21 and 22 that oppose to each other and a roof 23 connecting upper ends of the pair of side walls 21 and 22 are extended in a depth direction. The curtain 5 is provided along the roof 23 inside the house body 2. The curtain 5 is supported by the supporting part 6 extended in the depth direction (FIGS. 1A and 1B) and configured to be opened and closed along the depth direction.

Hereinafter, the configuration of the agricultural house 1 according to the present embodiment will be described in detail. If the width direction (short direction) of the agricultural house 1 is a first direction and the depth direction (longitudinal direction) of the agricultural house 1 is a second direction, the first direction is orthogonal to the second direction in a plane along a ground surface. That is, the depth direction (second direction) is orthogonal to the width direction (first direction) that is an opposite direction of the pair of side walls 21 and 22. Further, if the height direction of the agricultural house 1 is a third direction, the third direction is orthogonal to the first direction and the second direction. Hereinafter, the description is performed while setting the first direction, the second direction, and the third direction to the X-axis direction, the Y-axis direction, and the Z-axis direction, respectively.

That is, the house body 2 includes a pair of side walls 21 and 22 that oppose each other, and a roof 23 that connects upper ends of the pair of side walls 21 and 22. The agricultural house 1 is formed into a shape in which the pair of side walls 21 and 22 and the roof ere extended in the Y-axis direction (depth direction). In addition, in an example shown in FIG. 2, the house body 2 includes gable walls 24 that are arranged at both end parts of the house body 2 in the Y-axis direction. The gable walls 24 have a doorway (not shown) so that the person can enter into and go out the house body 2.

Specifically, the house body 2 includes a metal frames (frameworks) 3, such as aluminum, and a covering materials 4 that have translucency and are held at the frames 3. The covering materials 4 are provided so as to cover substantially whole of the house body 2. The covering materials 4 may be, for example, a transparent vinyl sheet or glass products so as to protect from rain and wind without hardly interrupting sunlight and obtain incubation and moisture in the house body 2. The covering materials 4 may include nets (such as insect screen) partially in consideration of air permeability.

The frame 3 includes two or more arch parts 31 and two or more connecting members 32. The two or more arch parts 31 have arch shapes and are located in a line with the Y-axis direction (depth direction). The two or more connecting members 32 each is extended in the Y-axis direction and connect the two or more arch parts 31. Each of the two or more arch parts 31 includes a pair of wall pieces 311 and 312 and a roof piece 313. The pair of wall pieces 311 and 312 are located along the Z-axis direction (height direction). The roof piece 313 connects upper ends of the pair of wall pieces 311 and 312.

That is, the two or more wall pieces 311 arranged in the Y-axis direction and the covering materials 4 provided between the two or more wall pieces 311 constitute the side wall 21. The two or more wall pieces 312 arranged in the Y-axis direction and the covering materials 4 provided between the two or more wall pieces 312 constitute the side wall 22. The two or more roof pieces 313 arranged in the Y-axis direction and the covering materials 4 provided between the two or more roof pieces 313 constitute the roof 23. Here, each arch part 31 is formed into a shape that serves as a convex in the upper part such as semicircular shape or triangular shape so that the roof piece 313 becomes high as being close to the central part in an X-axis direction (width direction). Therefore, the roof 23 is formed into a shape of a semicircular pillar shape or a triangle pole shape, for example.

The two or more connecting members 32 include a shoulder part 321 and a shoulder part 322. The shoulder part 321 connects the upper ends (connecting points with the roof piece 313) of the two or more wall pieces 311 arranged in the Y-axis direction. The shoulder part 322 connects the upper ends (connecting points with the roof piece 313) of the two or more wall pieces 312 arranged in the Y-axis direction. That is, the side walls 21 and 22 and the roof 23 of the house body 2 are divided by the shoulder parts 321 and 322. Further, the two or more connecting members 32 include a ridge part 323 in addition to the shoulder parts 321 and 322. The ridge part 323 connects the top parts of the two or more roof pieces 313 arranged in the Y-axis direction.

In addition, the frames 3 of the house body 2 further include beams 33. The beams 33 are arranged at the both end parts in the Y-axis direction along a plane (X-Z plane in FIG. 2) orthogonal to the Y-axis direction. The beams 33 support the roof 23 at least. Here, the word “orthogonal” includes the case where the both intersect with substantially a right angle in addition to the case where the both intersect with a right angle strictly. The beams 33 are provided inside each of the arch parts 31 that are respectively placed at the both ends in the Y-axis direction. That is, the gable wall 24 is constituted of the arch parts 31 of the both ends in the Y-axis direction and the beams 33, and the covering materials 4 provided inside these arch parts 31.

A fan 241 is provided at each gable wall 24 that is placed at the both ends of the house body 2 in the Y-axis direction. The fan 241 is a central part of the gable walls 24 in the X-axis direction, and is provided near the upper end part, and is supported by the beams 33. Therefore, in the agricultural house 1, airstream occurs forcibly in the house body 2 by operating (rotating) the fan 241, and this agricultural house 1 can ventilate the internal space inside the house body 2 (exchange of air).

Incidentally, in the agricultural house 1 of the present embodiment, the curtain 5 is provided along the roof 23 inside the house body 2 constituted as mentioned above. The curtain 5 is supported by supporting part 6 (refer to FIGS. 1A and 1B) extended in the Y-axis direction (depth direction), and constituted so as to open and close in the Y-axis direction along the supporting part 6. Here, as an example, the curtain 5 is a curtain for dimming which has protection-from-light rate of about 65 to 75%, and has a function of interrupting part of sunlight (solar radiation) irradiated in the house body 2 through the roof 23 in a full-closed state. In delicate vegetables or the like, if the light irradiated in the house body 2 is too strong, the efficiency of photosynthesis is worsen. However, the agricultural house .1 can adjust the intensity of radiation into the house body 2 and realize environment that is suitable for cultivation of agricultural products by having such a curtain 5 for dimming.

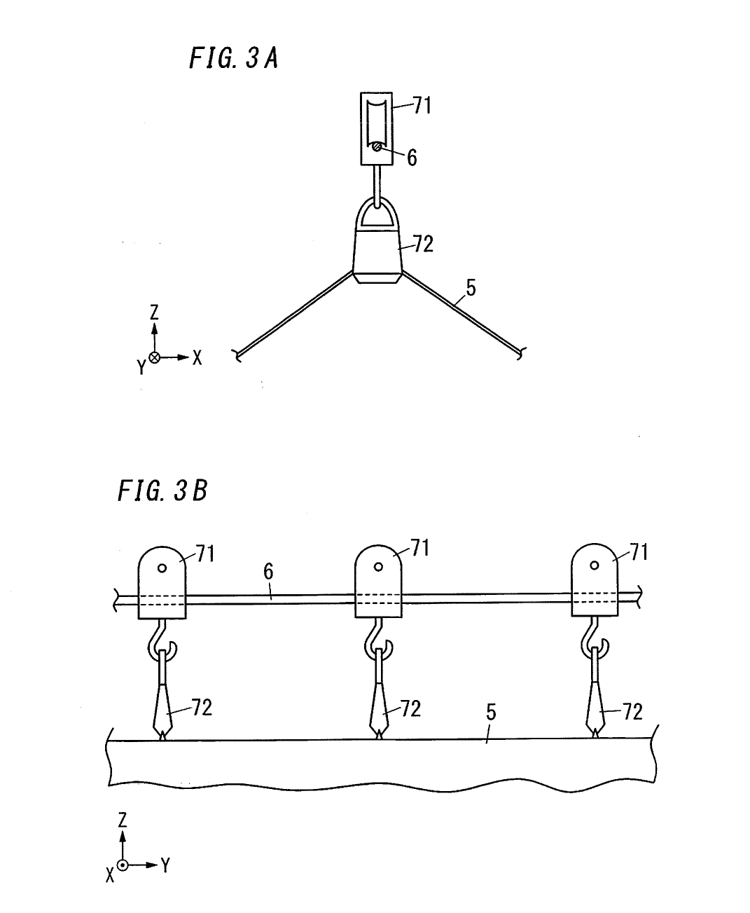

Hereafter, the specific composition of the curtain 5 and the supporting part 6 will be described with reference to FIGS. 1A, 1B, 3A, and 3B.

The supporting part 6 includes two or more linear members. The two or more linear members are stretched between the both ends of the house body 2 in the Y-axis direction, that is, between the pair of gable walls 24). Here, each linear member is a wire or a rope, for example. The supporting part 6 is arranged inside the house body 2, that is, at a position between the pair of side walls 21 and 22 and downward the roof 23.

According to the present embodiment, the supporting part 6 is fixed to the beam 33 (refer to FIG. 2). That is, since the beams 33 supporting the roof 23 at least is provided at the gable wall 24 placed at the both ends of the house body 2 in the Y-axis direction as mentioned above, in the agricultural house 1 of the present embodiment, the beams 33 are made to serve as components for fixing the both end parts of the supporting part 6. The curtain 5 is supported by the supporting part 6 while being hung by the supporting part 6.

The three or more supporting parts 6 are arranged in the X-axis direction (width direction) that is the opposite direction of the pair of side walls 21 and 22. Here, the “opposite direction” is a direction in which the pair of side walls 21 and 22 opposes to each other, that is, a direction of substantially intersecting with the both side walls 21 and 22. According to the present embodiment, the supporting part 6 is provided, by one, at each position near the shoulder parts 321 and 322 (refer to FIG. 2) and a position near the ridge part 323 (refer to FIG. 2). These three supporting parts 6 are arranged at substantially regular intervals in the X-axis direction (width direction). Here, these two or more of supporting parts 6 (three supporting parts in the present embodiment) have different heights at which the curtain is supported is higher according to the distance from the side wall 21 (or side wall 22) as the supporting parts 6 separate from the side wall 21 (or side wall 22). In other words, the two or more supporting parts 6 are arranged at higher positions with close to the center in the X-axis direction as shown in FIG. 1B. Therefore, the curtain 5 is supported along the shape of the roof 23 so that the central part in the X-axis direction becomes the highest.

As shown in FIGS. 3A and 3B, each supporting part 6 is provided with two or more pulleys 71. The two or more pulleys 71 are attached to the supporting part 6 so as to be arranged in the longitudinal direction (Y-axis direction). Each of these pulleys 71 is constituted so as to be capable of moving on the supporting part 6 along the supporting part 6. Therefore, the intervals between the pulleys 71 changes, which is adjacent to each other on the same supporting part 6 in the Y-axis direction. Clamps 72 for holding the curtain 5 are respectively connected with pulleys 71 by hung.

The curtain 5 is made of synthetic resin, for example, and has sufficient flexibility so that the curtain 5 is openable and closable. The curtain 5 is held so that parts thereof are respectively pinched by the clamps 72 connected with the pulleys 71. The curtain 5 is supported by the two or more supporting parts 6 so that two or more places in the X-axis direction are respectively hung by the two or more supporting parts 6. Therefore, each part of the curtains 5 held by the clamp 72 moves along the supporting part 6 in the Y-axis direction with movements of the pulleys 71. However, the clamp 72 holding one end part of the curtain 5 in the Y-axis direction is fixed at the frame 3 (beam 33) of the house body 2 so as not to move from one end part of the supporting part 6 in the longitudinal direction (Y-axis direction).

According to the above-mentioned composition, the clamp 72 connected with the pulley 71 moves with the curtain 5 in the Y-axis direction when the pulley 71 moves on the supporting part 6 along the supporting part 6. As a result, the curtain 5 is opened and closed. That is, when one end of the curtain 5 in the Y-axis direction is a fixed end and the other end of the curtain 5 in the Y-axis direction is a free end, the curtain 5 is opened and closed along the supporting part 6 in the Y-axis direction by moving a free end in the Y-axis direction with movement of the pulley 71 while fixing a fixed end to a regular position. Here, the “fixed end” is an end part that is fixed at the regular position, and the “free end” is an end part that is movable freely. Therefore, the curtain 5 becomes in a full-opened state when the free end is closest to the fixed end. The curtain 5 becomes in a full-closed state when the free end is farthest from the fixed end. The curtain 5 in the full-closed state covers the almost all region of the roof 23 in the house body 2.

Further, in this composition, when the two or more pulleys 71 is respectively attached to the two or more supporting parts 6 supporting the curtain 5, and the curtain 5 is in the full-closed state, the clamps 72 supported by the two or more of supporting parts 6 are placed on the same straight line along the X-axis direction. In other words, the curtain 5 is supported by the supporting part 6 so as to keep the same position in the Y-axis direction by the two or more clamps 72 respectively hung in the two or more supporting parts 6. Therefore, when changing from the full-closed state to the full-opened state, the curtain 5 is folded up so that parts between the parts held by the clamp 72 in the Y-axis direction hangs down. That is, the curtain 5 in the full-opened state is folded up so as to become crest folding at the parts held by the clamps 72.

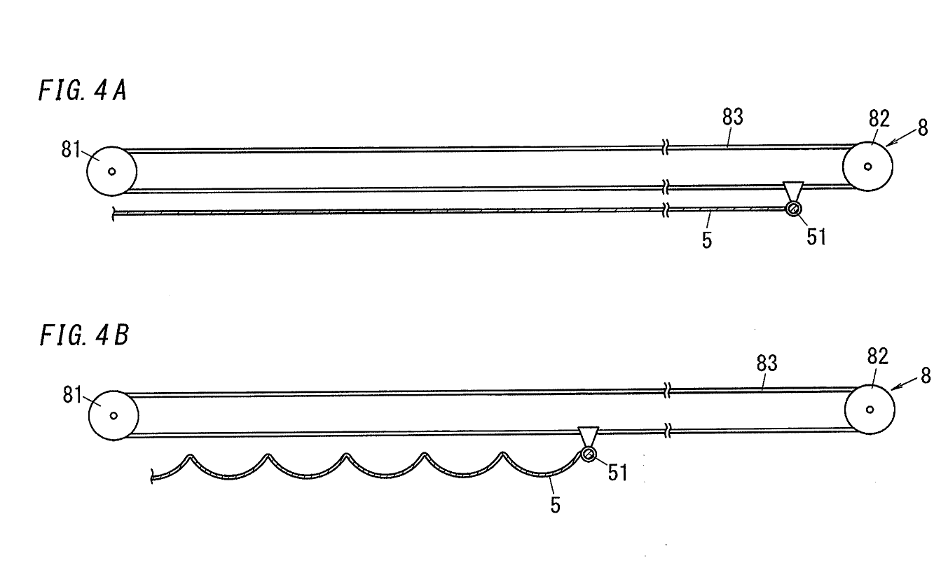

The agricultural house 1 of the present embodiment further includes an opening/closing apparatus 8 (refer to FIGS. 4A and 4B) for opening and closing the curtain 5 by moving the pulley 71 so that a user can open and close the curtain 5 comparatively easily.

As shown in FIGS. 4A and 4B, the opening/closing apparatus 8 includes fixed pulleys 81 and 82 and an annular string 83. The fixed pulleys 81 and 82 are fixed to both end parts of the house body 2 in the Y-axis direction. The string 83 is hung between the fixed pulleys 81 and 82. Here, the string 83 is a rope or a wire, for example. The string 83 has a part with which the free end of the curtain 5 is combined. Furthermore, in the present embodiment, the curtain 5 includes two or more hook tools (not shown), such as a hook, on the extension line of a binding part at which the string 83 and the curtain 5 in the Y-axis direction. The string 83 is inserted in these hook tools. If the clamps 72 or the pulleys 71 holding the curtain 5 have holes through which the string 83 is inserted, the string 83 may be inserted through these holes instead of the hook tools.

Therefore, the opening/closing apparatus 8 can move the free end of the curtain 5 together with the pulley 71 along the Y-axis direction by rotating the fixed pulleys 81 and 82 and moving the string 83. When closing the curtain 5, the opening/closing apparatus 8 moves the string 83 toward a direction in which the free end of the curtain 5 separates from the fixed end (state of FIG. 4A). When opening the curtain 5, the opening/closing apparatus 8 moves toward a direction in which the free end of the curtain 5 approaches the fixed end (state of FIG. 4B).

Here, the curtain 5 includes the core materials 51 and 52 (refer to FIG. 1B). The core materials 51 and 52 connect between both ends in the opposite direction (X-axis direction) of the pair of side walls 21 and 22. The curtain 5 is opened and closed by the core material 51 moving along the supporting part 6 in the Y-axis direction. That is, the both ends (the fixed end and the free end) of the curtain 5 in the Y-axis direction each is provided with the cylindrical core materials 51 and 52 extended in the X-axis direction. The opening/closing apparatus 8 includes 2 sets as a combination of the fixed pulleys 81 and 82 and the string 83 (refer to FIG. 1B). One set is the fixed pulleys 811 and 821 and the string 831. The other set is the fixed pulleys 812 and 822 and the string 832. In this opening/closing apparatus 8, the strings 831 and 832 of each set are connected with the both end parts of the core material 51 provided by the free end of the curtain 5.

Therefore, the opening/closing apparatus 8 can move simultaneously the both end parts of the core material 51 in the X-axis direction, which is provided at the free end of the curtain 5, by rotating the fixed pulleys 811, 821, 812, and 822 and moving both strings 831 and 832 simultaneously. Accordingly, the free ends of the curtain 5 move in the Y-axis direction at the same time over the both ends in the X-axis direction. Therefore, according to the agricultural house 1 of such a composition, the positions of the free ends of the curtain 5 can be arranged over the both ends in the X-axis direction, and it is possible to suppress the dispersion in the opening degree of the curtain 5 in the X-axis direction. As a result, the agricultural house 1 has the advantage that it is possible to easily to adjust the opening of the curtain 5. Here, the “opening degree” is a value showing an amount of opening of the curtain 5 when the curtain 5 is in the full-closed state is defined as a standard. For example, the opening degree is “0” when the curtain 5 is in the full-closed state, and the opening degree is “100” when the curtain 5 is in the full-opened state. Therefore, the opening degree is shown with ratio of opening area of the curtain 5 to the state where the curtain 5 is opened perfectly.

As for the opening/closing apparatus 8, it is desirable that the fixed pulley 811 is connected to the fixed pulley 812 with the shaft (not shown) and the fixed pulley 821 is connected to the fixed pulley 822 with the shaft (not shown) so that two sets of the fixed pulleys 81 and 82 may rotate simultaneously in the case where the curtain 5 is opened and closed at the same time over the all area in the X-axis direction. Therefore, when a set of fixed pulleys 811 and 821 rotate, the rotational force is transmitted to the fixed pulleys 812 and 822 of another side via the shaft, and then both strings 831 and 832 since move simultaneously. Accordingly, the opening/closing apparatus 8 can suppress the dispersion in the opening degree of the curtain 5 in the X-axis direction.

The opening/closing apparatus 8 may include a driving source (not shown), such as a motor, and be configured to and open and close the curtain 5 by rotating the fixed pulleys 81 and 82 with a driving force that the driving source generates, may be sufficient as the opening/closing apparatus 8. Alternatively, the opening/closing apparatus may be configured to open and close the curtain 5 by a user rotating the fixed pulleys 81 and 82 manually. Even if any configuration is used, when the fixed pulley 811 is connected to the fixed pulley 812 with the shaft and the fixed pulley 821 is connected to the fixed pulley 822 with the shaft as mentioned above, the opening/closing apparatus 8 can open and close the curtain 5 by rotating only the fixed pulleys 811 and 821 of one side.

The above-mentioned composition of the opening/closing apparatus 8 is only an example. The opening/closing apparatus 8 may be configured to open and close the curtain 5 by hauling in the string 83 combined with the free end of the curtain 5 without using the fixed pulleys 81 and 82, for example.

Incidentally, as shown in FIG. 2, the agricultural house 1 of the present embodiment further includes the watering apparatus 11 for watering.

The watering apparatus 11 includes a water injection part 111 and a tank 112. The water injection part 111 is provided in the house body 2. The tank 112 is configured to supply water to the water injection part 111. The water injection part 111 includes a pipe that is provided near each side wall 21 or 22 along the Y-axis direction. The pipe has holes (not shown) that are formed at appropriate intervals in the side surface thereof so that the water supplied from the tank 112 is injected in the house body 2. Here, in the watering apparatus 11, the water injection part 111 is provided at the position corresponding to each of the upper end part and the lower end part of each of the side walls 21 and 22. The water injection part 111 provided at the upper end part of the side walls 21 and 22 is configured to inject (spray) the water of mist shape from the water injection part 111 provided by the upper end part of the side walls 21 and 22.

The agricultural house 1 of the present embodiment includes a first side curtain 13 that is provided inside each side wall 21 or 22 and a second side curtain 14 that is provided outside each side wall 21 or 22. Here, as an example, the first side curtain 13 is made of the same material as the curtain 5, and has protection-from-light (dimming) property. The second side curtain 14 is transparent. The first side curtain 13 and the second side curtain 14 have upper end parts that are respectively fixed near the shoulder parts 321 and 322, and are configured to be capable of opening and closing freely in the Z-axis direction (height direction).

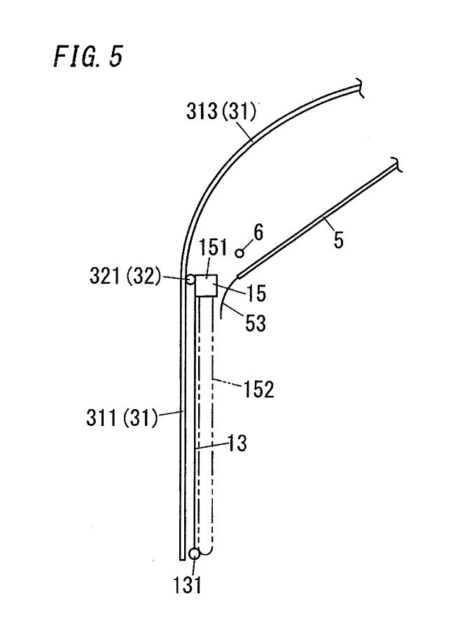

Specifically, when the upper end and the lower end are respectively used as the fixed end and the free end, the first and the second side curtains 13 and 14 are opened and closed in the Z-axis direction by the height position of the free end from a ground surface being changed. Here, since the composition for opening and closing of the first side curtain 13 is the same as that of the second side curtain 14, hereinafter, the configuration thereof will be described with reference to FIG. 5 in detail in the case where the first side curtain 13 is considered as an example.

As shown in FIG. 5, the side curtain 13 includes a cylindrical core material 131 that is provided at a lower end part of the side curtain 13. Here, the opening/closing apparatus 15 for opening and closing the first side curtain 13 includes fixed pulleys 151 and strings 152. The fixed pulleys 151 are fixed to the upper end parts of the side walls 21 and 22. The strings 152 are configured to be capable of being winded by the fixed pulleys 151. Each fixed pulley 151 has a configuration in which disk-shaped pulley body is housed in a rectangular case.

Here, each string 152 is a rope or a wire, for example. The string 152 has a part that is combined with the free end of the side curtain 13. Furthermore, in the present embodiment, the side curtain 13 includes two or more hook tools (not shown), such as a hook, that are provided on the extension line from a binding site combined with the string 152 in the Z-axis direction. The string 152 is inserted in these hook tools.

Therefore, the opening/closing apparatus 15 can move the free end of the side curtain 13 with the core material 131 in the Z-axis direction by rotating the fixed pulley 151 and moving the string 152. When opening the side curtain 13, the opening/closing apparatus 15 moves the string 152 so that the core material 131 goes up. When closing the side curtain 13, the opening/closing apparatus 15 moves the string 152 so that the core material 131 descends.

Here, the opening/closing apparatus 15 has two sets of combination of the fixed pulley 151 and the string 152. The string 152 of each set is combined with the both end parts of the core material 131 provided at the free end of the side curtain 13. Therefore, the opening/closing apparatus 15 can move simultaneously the both end parts in the Y-axis direction, of the core material 131 provided at the free end of the side curtain 13 by rotating the fixed pulley 151 and moving both strings 152 simultaneously. Therefore, since the free ends move in the Z-axis direction at the same time over the both ends in the Y-axis direction, the side curtain 13 is opened and closed at the same time over all area in the Y-axis direction. Therefore, according to the agricultural house 1 of such a composition, the position of the free ends of the first side curtain 13 can be arranged for the both ends in the Y-axis direction, and then it is possible to suppress the dispersion in the opening degree of the first side curtain 13 in the Y-axis direction.

As for the opening/closing apparatus 15, when the side curtains 13 are opened and closed at the same time over all area in the Y-axis direction, it is desirable that the fixed pulleys 151 are connected with the shaft (not shown) so that the two sets of fixed pulleys 151 rotate simultaneously. Therefore, when one fixed pulley 151 rotates, a rotational force is transmitted to the other fixed pulley 151 via the shaft, and the both strings 152 move simultaneously. Accordingly, the opening/closing apparatus 15 can suppress the dispersion in the opening degree of the side curtain 13 in the Y-axis direction.

The opening/closing apparatus 15 may include a driving source (not shown), such as a motor, and be configured to open and close the side curtain 13 by rotating the fixed pulley 151 with driving force that the driving source generates. Alternatively, the opening/closing apparatus 15 may be configured to open and close the side curtain 13 by a user rotating the fixed pulley 151 manually. Even if any configuration is used, when the fixed pulleys 151 are connected with the shaft as mentioned above, the opening/closing apparatus 15 can open and close the side curtain 13 by rotating only the one fixed pulley 151.

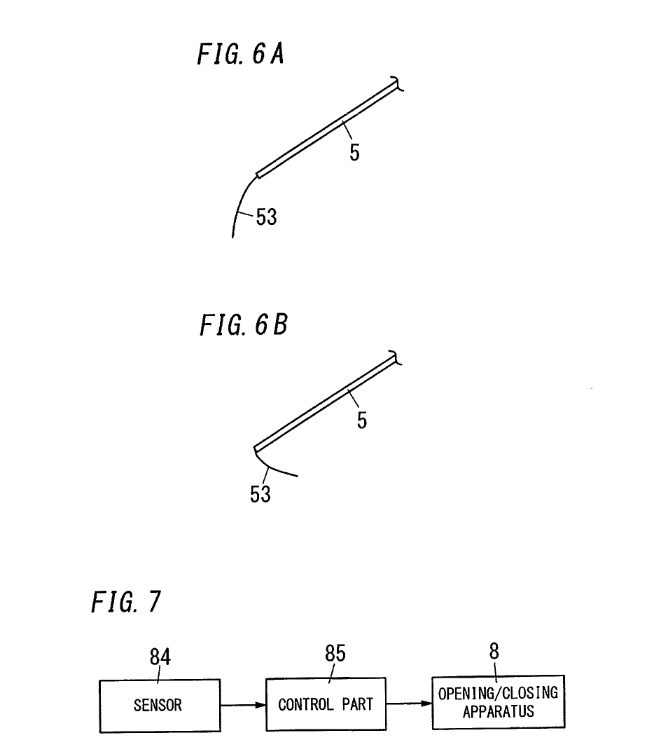

Here, in the case where the agricultural house 1 of the above-mentioned configuration has a gap between the curtain 5 and the side curtain 13, even when the curtain 5 and the side curtain 13 are closed, there is possibility that sunlight is irradiated in the house body 2 through this gap. In the agricultural house 1 of the present embodiment, as shown in FIG. 6A, the curtain 5 includes flap parts 53. The flap parts 53 are hung down from the both end parts in the X-axis direction. Each flap part 53 narrows the gap between the side curtain 13 and the curtain 5. However, the curtain 5 moves in the Y-axis direction at the time of opening and closing. Therefore, if the curtain 5 is opened and closed in the state where the flap parts 53 are hung down, there is possibility that the flap parts 53 interfere with the side curtain 13, the frame 3 of the house body 2, and the like.

Then, the curtain 5 of the agricultural house 1 of the present embodiment includes a folding mechanism (not shown). The folding mechanism is configured to fold back the flap part 53 to an inside as shown in FIG. 6B at the time of the opening and closing when the curtain 5 moves in the Y-axis direction. The folding mechanism includes, for example, a reversal spring. The folding mechanism is configured to be capable of switching a stationary state in the FIG. 6A where the flap parts 53 are hung down and a folding state in the FIG. 6B where the flap parts 53 are folded back to the inside. The folding mechanism is configured to change the folding state forcibly by the reversal spring when the flat parts 53 are folded back to the inside to certain degree in the case where the stationary state is switched to the folding state by the reversal spring. In the case where the folding state is switched to the stationary state, the folding mechanism is configured to change the stationary state forcibly by the reversal spring when the flat parts 53 are opened to the outside.

The folding mechanism may be configured to switch from the stationary state to the folding state automatically as at the time of opening and closing of the curtain 5. The folding mechanism may have a configuration so that a user switches the stationary state and the folding state manually. The agricultural house 1 can prevent interference with the first side curtain 13, the frame 3 of the house body 2, and the like at the time of opening and closing of the curtain 5 by providing such a folding mechanism on the curtain 5.

The side curtains 13 and 14 may be configured to be opened and closed in the Y-axis direction like the curtain 5.

According to the agricultural house 1 of the present embodiment described above, the curtain 5 is supported by the supporting part 6 extended in the Y-axis direction (depth direction), and configured to be opened and closed along the supporting part 6 in the Y-axis direction. Therefore, it is possible to suppress deterioration of intensity of radiation with the curtain 5 of the full-opened state.

That is, in the configuration that the curtain 5 generally is opened and closed not in the Y-axis direction but in the X-axis direction, the curtain 5 in the full-opened state is collected near the top part of the roof 23 of the house body 2, or near the connecting part between the roof 23 and the side walls 21 and 22. On the other hand, in the agricultural house of the present embodiment, since the curtain 5 in the full-opened state is collected at the end of the house body 2 in the Y-axis direction, the curtain 5 is not collected at a place in which the curtain 5 interrupts the solar radiation into the house body 2 at the time when the curtain 5 is in the full-opened state.

As a result, the agricultural house 1 can avoid that intensity of radiation is deteriorated and affecting growing of agricultural products with the curtain 5, and can provide environment suitable for cultivation of agricultural products. Further, since a doorway, the tank 112 for watering, and the like are installed near the gable wall 24 in the house body 2, agricultural products are not planted near the gable wall 24. Therefore, the curtain 5 collected at the gable wall 24 at the time of the full-opened state does not affect growing of agricultural products.

Further, since the curtain 5 is supported by the supporting part 6 extended in the Y-axis direction, the agricultural house 1 can suppress the material cost and time and effort for adding the curtain 5 to the house body 2 compared with the composition in which the curtain 5 is supported by the piano wire or the like extended in the X-axis direction.

In the agricultural house 1 of the present embodiment, the house body 2 preferably includes the beams 33. Preferably, the beams 33 are arranged at the both end parts in the Y-axis direction (depth direction) along the plane orthogonal to the Y-axis direction, and support the roof 23 at least. The supporting part 6 is preferably fixed to the beams 33. According to this configuration, the agricultural house 1 does not need to add a dedicated component to the house body 2 in order to fix the supporting part 6 that supports the curtain 5, since attaching the supporting part 6 using the beams 33 provided in the house body 2 from the first.

Further, the three or more supporting parts 6 are preferably arranged in the opposite direction (X-axis direction) of the pair of side walls 21 and 22. Preferably, the supporting parts 6 have different heights at which the supporting parts 6 support the curtain 5 according to the distance from the side walls 21 and 22 so that the heights of the curtain 5 become higher with separating from the side walls 21 and 22. Therefore, since the curtain 5 is supported at the higher position with close to the central part in the X-axis direction, it is not hard that the curtain 5 interferes with the user who stands and works in the house body 2. The curtain 5 can avoid interference with the fan 241 that is provided near the upper end part of the central part of the gable wall 24 in the X-axis direction. Therefore, the curtain 5 can avoid hindering the airstream generated by the fan 241.

In each end part in the Y-axis direction (depth direction), the curtain 5 preferably includes the core materials 51 and 52. The core materials 51 and 52 preferably connect between the both ends of the pair of side walls 21 and 22 in the opposite direction (X-axis direction) at least. The curtain is preferably opened and closed by the core materials 51 and 52 moving along the supporting part 6 in the Y-axis direction. On the other hand, the curtain 5 includes the core materials 51 and 52 that connect at least the both end parts in the X-axis direction at the both end parts in the Y-axis direction. According to this configuration, the both end part of the curtain 5 are opened and closed simultaneously. Therefore, it is possible to suppress the dispersion in the opening degree of the curtain 5 in the X-axis direction.

Incidentally, as a modification of the present embodiment, as shown in FIG. 7, the agricultural house 1 may further include the sensor 84 and the control part 85 in addition to the opening/closing apparatus 8 opening and closing the curtain 5 as mentioned above. The sensor 84 is installed inside the house body 2 and configured to detect the environment information that includes temperature at least. The control part 85 is configured to control the opening/closing apparatus 8 according to the detection result of the sensor 84.

In the modification, the sensor 84 includes, for example, the temperature sensor, the humidity sensor, and the illuminance sensor and is configured to detect the temperature (room temperature), the humidity, and the illumination of the inner space in the house body 2 as the environment information, sensor. The control part 85 is configured to control the driving source (not shown), such as the motor of the opening/closing apparatus 8, so that the curtain 5 is opened and closed automatically according to the detection result of the sensor 84.

According to the modification, the control part 85 can open and close the curtain 5 automatically according to the environment in the house body 2. Therefore, the control part 85 can maintain the inside of the house body 2 to desired environment. For example, when the temperature in the house body 2 is lower than a predetermined target temperature, the control part 85 controls the opening/closing apparatus 8 to open the curtain 5 and increase the temperature in the house body 2.

### Second Embodiment

An agricultural house 1 of the present embodiment is different from the agricultural house 1 of the first Embodiment in that a curtain 5 is divided in a Y-axis direction (depth direction). Hereafter, the same components as the first embodiment are attached with the common reference, and the explanations thereof are appropriately omitted.

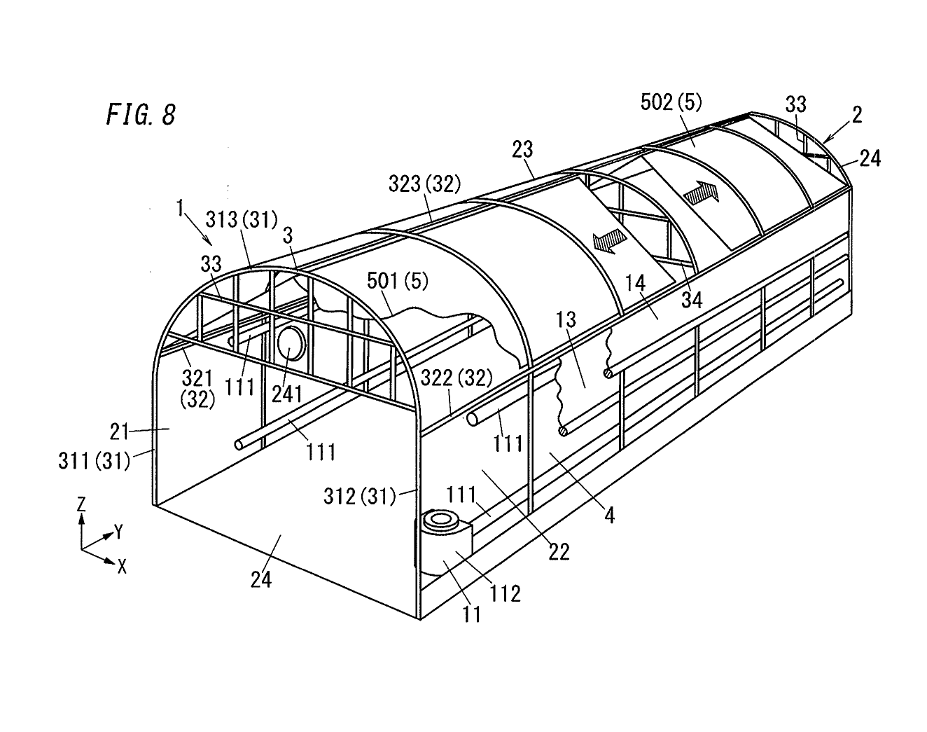

According to the present embodiment, as shown in FIG. 8, the curtain 5 is equally divided into a first curtain 501 and a second curtain 502 (hereinafter, referred to as “the curtain 5” when not distinguishing each in particular) that have the same length in the Y-axis direction. As an example, when the overall length of the house body 2 in the Y-axis direction is 50 m, the length of each curtain 5 in the Y-axis direction is set as 25 m. The supporting part 6 is extended over the overall length of the house body 2 in the Y-axis direction, and is common to both curtains 5. Each curtain 5 is fixed to the frame 3 (beam 33) of the house body 2 so that one end part in the Y-axis direction does not move from each end of the supporting part 6 in a longitudinal direction (Y-axis direction).

According to this composition, one end and the other end of both ends of the house body 2 in the Y-axis direction are respectively set to a fixed end and a free end. Each curtain 5 is opened and closed in the Y-axis direction by moving the free end with the movement of the pulley 71 (refer to FIG. 3B) while fixing the fixed end at a regular position. Therefore, both the curtains 501 and 502 generated by the curtain 5 being divided into two are in the full-opened state in the case where the mutual free ends are farthest from each other. The both the curtains 501 and 502 are in the full-closed state in the case where the mutual free ends are closest to each other. The curtains 5 are openable and closable individually, and the opening/closing apparatus (not shown) is also provided for each of the curtains 501 and 502.

According to the agricultural house 1 of the present embodiment described above, even if the length of the house body 2 in the Y-axis direction is comparatively long, since the curtain 5 is divided in the Y-axis direction, the weight of each curtain 501 and 502 can be decreased. Therefore, in the agricultural house 1, when a user opens and closes the curtain 5 manually, it is possible to open and close the curtain 5 with comparatively small power, and when opening/closing apparatus opens and closes the curtain 5 automatically, it is possible to decrease a load added to the opening/closing apparatus small.

In the present embodiment, the frame 3 of the house body 2 further includes intermediate beam 34. The intermediate beam 34 is arranged along the plane orthogonal to the central part in the Y-axis direction, and supports the roof 23 at least. The supporting part 6 is fixed to the beam 33 and the intermediate beam 34. Therefore, even if the length of the house body 2 in the Y-axis direction is comparatively long, the supporting part 6 provided over the both ends in the Y-axis direction is supported at three points of the both end parts and a central part of the house body 2.

Therefore, the agricultural house 1 can avoid that the supporting part 6 bends with weight thereof and the weight of the curtain 5 even when the length of the house body 2 in the Y-axis direction is comparatively long. Here, if bending arises in the supporting part 6, it is hard to move the pulley 71, and then it is difficult to smoothly open and close the curtain 5. If a tension is applied to the supporting part 6 too much, it is necessary to raise the strength of the supporting part 6 and the strength of the frame 3 of the house body 2. On the other hand, the agricultural house 1 of the present embodiment prevents the supporting part 6 from bending without applying the tension to the supporting part 6 more than necessary. Therefore, the agricultural house 1 can smoothly open and close the curtain 5 without raising the strength of the supporting part 6 and the strength of the frame 3 of the house body 2. Further, the fun may be supported by the intermediate beam 34. In this case, the agricultural house 1 can ventilate the internal space of the house body 2 more efficiently.

The supporting part 6 may be divided into two parts by the intermediate beam 34 in the Y-axis direction. In this case, since each curtain 5 is supported by the two divided supporting parts, the agricultural house 1 can avoid that it becomes hard to move the pulley 71 by the supporting part 6 bending.

The curtain 5 is not limited to be divided into the two parts in the Y-axis direction as mentioned above. The curtain 5 may be divided into three or more parts in the Y-axis direction. In this case, the intermediate beam 34 may be provided at two or more points between the both end parts of the house body 2 in addition to the central part of the house body 2 in the Y-axis direction.

The other components and functions are the same as those of the first embodiment.

### Third Embodiment

An agricultural house 1 of the present embodiment is different from the agricultural house 1 of first embodiment in that a configuration of an opening/closing apparatus for opening and closing a curtain 5. Hereafter, the same components as the first embodiment are attached with the common reference, and the explanations thereof are appropriately omitted.

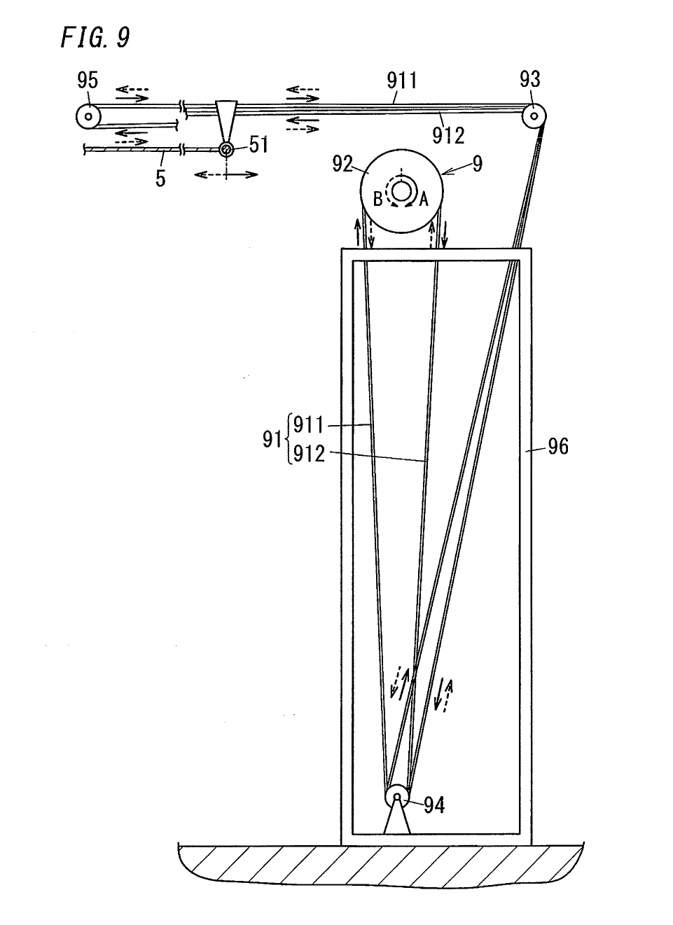

According to the present embodiment, as shown in FIG. 9, an opening/closing apparatus 9 includes a rotating drum 92 and a first pulley 93, and a second pulley 94. The rotating drum 92 is configured to, by winding the string 91 combined with a free end that is an end of the curtain 5 in the Y-axis direction, move the free end in the Y-axis direction. The first pulley 93 is configured so that the string 91 is hung between the rotating drum 92 and the free end. The second pulley 94 is configured so that the string 91 is hung between the rotating drum 92 and the first pulley 93.

Hereinafter, the configuration of the opening/closing apparatus 9 will be described in detail.

That is, the opening/closing apparatus 9 includes the string 91, the rotating drum 92, the first pulley 93, and the second pulley 94. Here, the string 91 is, for example, a rope or a wire like the string 83 (refer to FIGS. 4A and 4B) of the first embodiment. The free end of the curtain 5 is connected to part of the string 91. The string 91 is hung with the first pulley 93 between the rotating drum 92 and the free end of the curtain 5. The string 91 is hung with the second pulley 94 between the rotating drum 92 and the first pulley 93. Further, in an example shown in FIG. 9, the opening/closing apparatus 9 includes a folding pulley 95.

The first pulley 93 and the folding pulley 95 includes a fixed pulley that is fixed to both end parts of the house body 2 in the Y-axis direction, and is arranged along a roof 23 of the house body 2, that is, near the roof 23. That is, the rotating drum 92 and the first pulley 93 are arranged near the roof 23. Here, the rotating drum 92 is a position between the first pulley 93 and the folding pulley 95 in the Y-axis direction, and is arranged near the first pulley 93. Furthermore, the first pulley 93 and the folding pulley 95 are arranged at positions that have the same height. The rotating drum 92 is arranged at a position that is a little lower than the positions at which the first pulley 93 and the folding pulley 95 are arranged.

The second pulley 94 is arranged downward the rotating drum 92 and the first pulley 93. Here, the second pulley 94 includes a fixed pulley that is fixed to a regular position near a ground surface (surface of the earth). The second pulley 94 is arranged just under the rotating drum 92.

In the present embodiment, although the string 91 is one string in which both ends are held by the rotating drum 92, the string 91 is folded back at a position of the folding pulley 95 as a returned point. Therefore, two strings are pulled out from the rotating drum 92 apparently. Hereinafter, as a matter of convenience of description, in the two strings between the rotating drum 92 and the free end of the curtain 5, one string is called a first string 911, and the other string is called a second string 912. That is, the two strings 91 of the first string 911 and the second string 912 are pulled out from the rotating drum 92. A tip (an end on an opposite side of the rotating drum 92) of the first string 911 is connected to a tip (an end on the opposite side of the rotating drum 92) of the second string 912, tips.

Here, the tip of the second string 912 is folded back by the folding pulley 95 and connected with the first string 911. Therefore, the free ends of the curtain 5 are moved toward a direction in which the free ends separate from the folding pulley 95 when the first string 911 is winded, and the free ends of the curtain 5 are moved toward a direction in which the free ends approach the folding pulley 95 when the second string 912 is winded.

The first string 911 and the second string 912 each is hung on the first pulley 93 between the rotating drum 92 and the free end of the curtain 5, and are further hung on the second pulley 94 between the rotating drum 92 and the first pulley 93. In other words, a portion pulled out from the rotating drum 92 of each of the first string 911 and the second string 912 is folded back by the second pulley 94, and then connected with the free end of the curtain 5 via the first pulley 93. The first pulley 93 and the second pulley 94 include a two-ream pulley that includes two pulleys rotating independently.

The rotating drum 92 is equally divided into two partitions in a rotating shaft direction thereof, and one partition of the two partitions is used for the winding of the first string 911, and the other partition is used for the winding of the second string 912. However, a direction in which the first string 911 is winded is opposite to a direction in which the second string 912 is winded. When the rotating drum 92 rotates in a direction of an arrow A shown in FIG. 9 (solid line), the first string 911 is winded. When the rotating drum 92 rotates in a direction of an arrow B (dotted line), the second string 912 is winded. The tips of the first string 911 and the second string 912 are connected each other. Therefore, when the first string 911 is winded, the second string 912 is pulled out from the rotating drum 92. When the second string 912 is winded, the first string 911 is pulled out from the rotating drum 92.

Therefore, the opening/closing apparatus 9 can move the string 91 and move the free end of the curtain 5 in the Y-axis direction by rotating the rotating drum 92. When closing the curtain 5, the opening/closing apparatus 9 rotates the rotating drum 92 in the direction of the arrow A of FIG. 9 (solid line), and hauls the free end of the curtain 5 toward a side of the first pulley 93 with the first string 911, and moves the free ends of the curtain 5 in the direction in which the free ends separate from the fixed end. On the other hand, when opening the curtain 5, the opening/closing apparatus 9 rotates the rotating drum 92 in the direction of the arrow B of FIG. 9 (dotted line), and hauls the free end of the curtain 5 toward a side of the folding pulley 95 with the second string 912, and moves the free end of the curtain 5 in the direction in which the free ends approach the fixed end.

Like the first embodiment, in each end part in the Y-axis direction, the curtain 5 includes the core materials 51 and 52 (refer to FIG. 1B) that connect between the both ends at least in X-axis direction, and it is opened and closed by the core material 51 moving along the supporting part 6 in the Y-axis direction. Therefore, the opening/closing apparatus 9 includes two sets of combination, which includes the string 91, the rotating drum 92, the first pulley 93, the second pulley 94, and the folding pulley 95. The string 91 of each set is combined with the both end parts of the core material 51 provided at the free ends of the curtain 5. That is, the opening/closing apparatus 9 can move simultaneously the both end parts, in the X-axis direction, of the core material 51 provided at the free end of the curtain 5 by rotating the both rotating drums 92 and moving the both strings 91 simultaneously.

Thus, when the curtains 5 is opened and closed at the same time over all areas in the X-axis direction, it is desirable that two sets of rotating drums 92 are connected with the shaft (not shown) so that the rotating drums 92 rotate simultaneously. Therefore, when one rotating drum 92 rotates, rotational force is transmitted toward the other rotating drum 92 via the shaft, and both strings 91 move simultaneously. Accordingly, the opening/closing apparatus 9 can suppress dispersion in the opening degree of the curtain 5 in the X-axis direction.

The opening/closing apparatus 9 may include a driving source (not shown), such as a motor, and be configured to open and close the curtain 5 by rotating the rotating drum 92 with the driving force that the driving source generates. The opening/closing apparatus 9 may be configured so that a user rotates the rotating drum 92 manually and opens and closes the curtain 5. Even if any composition is used, when the rotating drums 92 are connected with each other via the shaft as mentioned above, the opening/closing apparatus 9 can open and close the curtain 5 by rotating only one rotating drum 92.

According to the agricultural house 1 having the configuration described above, the string 91 is folded back between the rotating drum 92 and the first pulley 93 by the rotating drum 92 arranged along the roof 23 and the second pulley 94 arranged under the first pulley 93. Therefore, even if the agricultural house 1 does not have a spatial margin above the rotating drum 92 and the first pulley 93, it is possible to secure a distance from the rotating drum 92 to the second pulley 94 by using a space lower than the rotating drum 92 and the first pulley 93. That is, the agricultural house 1 can secure the distance from the rotating drum 92 to the second pulley 94 comparatively largely by using the space inside the house body 2 effectively without raising the height of the house body 2. A fleet angle of the rotating drum 92 becomes small by enlarging the distance from the rotating drum 92 to the second pulley 94. Accordingly, the rotating drum 92 can wind the string 91 finely.

As shown in FIG. 9, it is desirable that a fence 96 is provided downward the rotating drum 92 and the first pulley 93, and the fence 96 is provided so that the circumference of the second pulley 94 and the string 91 are surrounded, and the second pulley 94 is fixed to the fence 96. The fence 96 has a rectangular-tube shape in which a cross section orthogonal to the Y-axis direction has an approximately square shape. The fence 96 fixes the second pulley 94 at a lower end part in the inside of the fence 96. Therefore, the circumferences of the string 91 between the rotating drum 92 and the second pulley 94 and the string 91 between the first pulley 93 and the second pulley 94 are surrounded with the fence 96.

The fence 96 is provided downward the rotating drum 92 and the first pulley 93 in order to prevent the contamination to the string 91. Each surface of the fence 96 may be configured of a component of translucency, such as polycarbonate, and may be configured of a net or the like.

The agricultural house 1 can prevent the contamination to the string 91 by such a fence 96 being provided while the second pulley 94 is provided downward the rotating drum 92 and the first pulley 93. Further, since the second pulley 94 is fixed to the fence 96, it is not necessary to newly install a component for fixing the second pulley 94. Also, the second pulley 94 can adjust a tension to the string 91 by adjusting, in the Z-axis direction, the fixed position of the fence 96 at which the second pulley 94 is fixed.

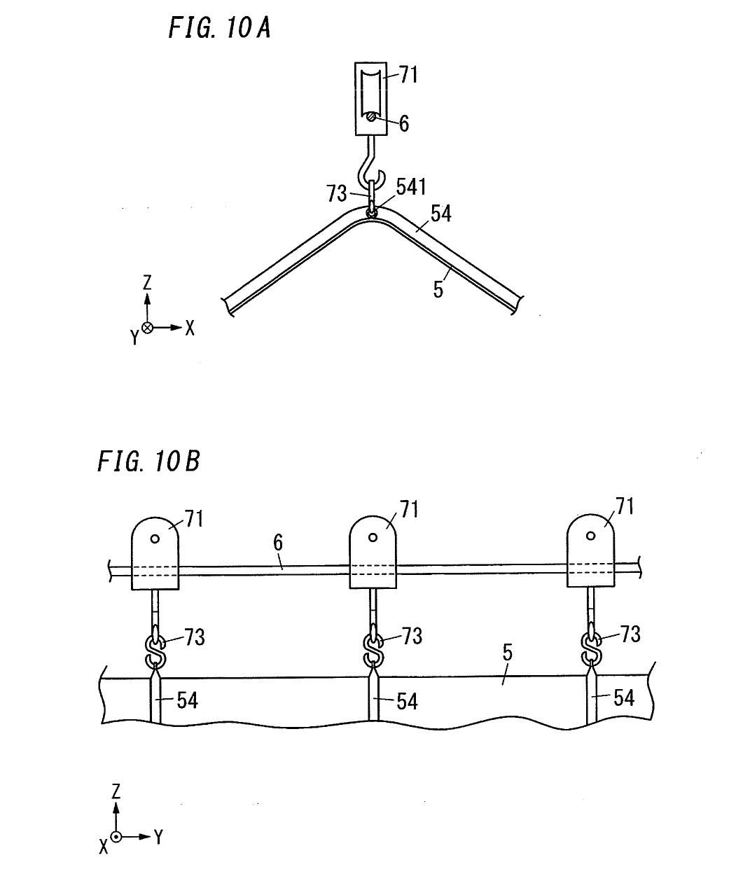

As shown in FIGS. 10A and 10B, the curtain 5 desirably includes the reinforcing bands 54. The reinforcing bands 54 desirably have higher strengths than the other parts of the curtain 5 and are extended over the both ends in the opposite direction of the pair of side walls 21 and 22. The reinforcing bands 54 of the curtain 5 are desirably supported by the supporting part 6. In this case, the two or more reinforcing bands 54 are arranged at predetermined intervals in the Y-axis direction.

That is, the curtain 5 includes the strip-shaped reinforcing band 54 extended over the both ends in the X-axis direction. However, the reinforcing band 54 is not limited to the configuration that the reinforcing band 54 is provided without intervals (continuously) in the all range from the one end to the other end of the curtain 5 in the X-axis direction. For example, there may be a gap between both ends of the reinforcing band 54 in the X-axis direction and both ends of the curtain 5 in the X-axis direction.

The reinforcing band 54 is configured by attaching, to the curtain 5, a strip-like component that has higher intensity (it is hard to bend) than the other part of the curtain 5, here, the component formed of material that is different from material of the curtain 5. The two or more reinforcing bands 54 are provided at the curtain 5 at the predetermined intervals (substantially regular intervals in the present embodiment) in the Y-axis direction. The intervals of the reinforcing bands 54 in the Y-axis direction are not necessary the same. The reinforcing bands 54 may be formed by increasing the thickness of the curtain 5 partially, for example.

By the portion of the reinforcing band 54 being held at the pulley 71, the curtain 5 is supported by the supporting part 6 so that the portion of the reinforcing band 54 is hung by the supporting part 6. Therefore, since a fold is made along the reinforcing band 54 at the time of opening, opening and closing of the curtain 5 is performed smoothly. Since the curtain 5 is folded up comparatively compactly in the Y-axis direction by the full-opened state by the fold being made along the reinforcing band 54, it is possible to suppress further deterioration of intensity of radiation with the curtain 5 of the full-opened state.

The curtain 5 has the eyelets 541 of the same number as the supporting parts 6 in each reinforcing band 54. The curtain 5 is held at the pulley 71 by the hooks 73 connected with the pulley 71 passing through the eyelets 541. That is, the curtain 5 is hung by the pulley 71 using the eyelets 541 currently formed in the previously regular position.

Therefore, when attaching the curtain 5, a worker only lets the hooks 73 pass to the eyelets 541 currently provided at the regular position, and can hang the curtain 5 to the supporting part 6 easily. The worker can make small position dispersion (positional displacement) of the portions held at the pulley 71 in the curtain 5 compared with the case where each part of the curtain 5 is pinched by a clamp. Since each eyelet 541 is provided at the reinforcing band 54, the curtain 5 can secure sufficiently the strength of the portion hung by the pulley 71.

In the present embodiment, the pulley 71 includes a hook tool (not shown) like the hook hooked on the supporting part 6 as fixing structure to the supporting part 6. The portion of a hook tool has spring elasticity so that the width of the releasing part into which the supporting part 6 is passed may be made variable. Therefore, even if the worker does not use a fixture, the worker can perform easily attachment of the pulley 71 to the supporting part 6 and removal of the pulley 71 from the supporting part 6, and his workability improves.

The pulley 71 is configured to have a margin so that inclination of the axis of rotation and displacement of the axis of rotation in the surface orthogonal to the axis of rotation may be permitted some extent. Therefore, even if the tensions of the supporting part 6 have different from each other in the Y-axis direction of the house body 2, the pulley 71 can operate comparatively smoothly in the substantially all region in the Y-axis direction of the supporting part 6.

Incidentally, the agricultural house 1 of the present embodiment has the characteristics also in arrangement of the supporting part 6.

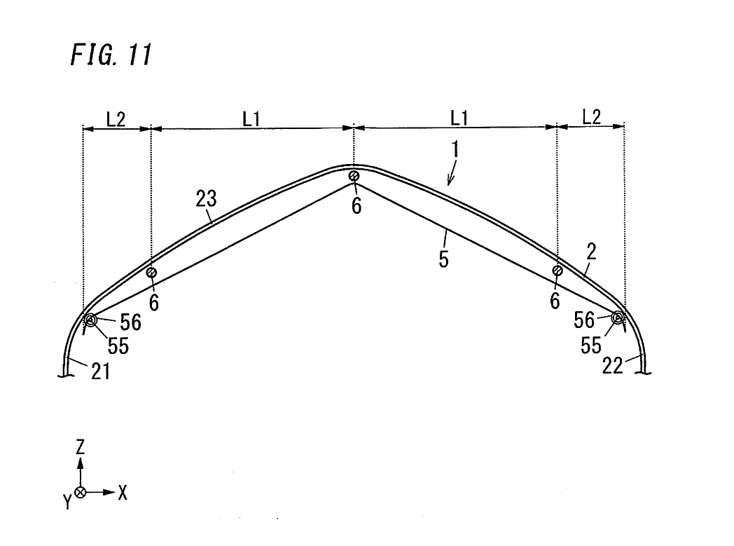

That is, the supporting part 6 is arranged above the curtain 5, and is supported by hanging the curtain 5. Here, as shown in FIG. 11, it is desirable that a pair of supporting parts 6, which are placed at both ends in the X-axis direction (depth direction), among the two or more supporting parts 6 (three supporting parts in FIG. 11) hung the part between the central part and both end parts in the X-axis direction in the curtain 5. Here, the “part between the central part and both end parts” means a part that separates from the center of the curtain 5 in the X-axis direction and separates from the both ends of the curtain 5 in the X-axis direction by a certain degree.

Specifically, the two or more supporting parts 6 are arranged upper than the shoulder parts 321 and 322 that divides the side walls 21 and 22 and the roof 23 of the house body 2. The pair of supporting parts 6 that are placed at the both ends in the X-axis direction is arranged at a corresponding position between the central part and both end parts of the curtain 5 in the X-axis direction, in a space between the roof 23 and each surface obtained by connecting each shoulder part 321 or 322 and the supporting part .6 that are placed at the center in the X-axis direction.

Thus, when the pair of supporting parts 6 that are placed at the both ends in the X-axis direction hangs the parts between the central part and both end parts of the curtain 5 in the X-axis direction, dispersion in the load to the two or more supporting parts 6 becomes small. That is, since the two or more supporting parts (here three) 6 are arranged at the higher positions as the supporting parts 6 are closer to the center in the X-axis direction. In the composition in which the pair of supporting parts 6 placed at the both ends in the X-axis direction support the both end parts of the curtain 5, the loads to the pair of supporting part 6 become smaller than others. On the other hand, in the present embodiment, since the pair of supporting parts 6 placed at the both ends in the X-axis direction have hung not at the both end parts of the curtain 5 but parts between the central part and both end parts in the X-axis direction in the curtain 5, it is possible to attain the equation of the load to the two or more supporting parts 6.

As a result, according to the agricultural house 1 of the present embodiment, although the curtain 5 is configured to be supported along the form of the roof 23 and not to produce useless space easily between the roof 23 and the curtain 5 so that the central part in the X-axis direction becomes the highest, it becomes possible to move smoothly to the supporting part 6. In short, the agricultural house 1 has the advantage that the space in the house body 2 can be used effectively in addition to realize the smooth movement of the curtain 5 to the supporting part 6.

Furthermore, in the present embodiment, the pair of supporting parts 6 placed at the both ends in the X-axis direction are arranged at the position of both-end sides rather than the middle point between the center in the X-axis direction and both ends in the curtain 5. The pair of supporting parts 6 placed at the both ends in the X-axis direction (width direction) hang the parts closer to the both end parts than the central part of the curtain 5 in the X-axis direction. In the example of FIG. 11, the distances L1 from the pair of supporting parts 6 to the center of the curtain 5 in the X-axis direction are set so as to be longer than the distances L2 from the pair of supporting part 6 to the both ends of the curtain 5 in the X-axis direction (L1>L2). According to this composition, even if the weight of the portions at the outer sides (sides of side walls 21 and 22) of the pair of supporting parts 6 placed at the both ends in the X-axis direction among the curtains 5 is applied to the supporting part 6 of these couples, the load to the supporting part 6 can be suppressed comparatively small. When the linear member mentioned later is provided, the load to a linear member is also suppressed comparatively small.

As shown in FIG. 11, the agricultural house 1 is desirably provided with linear members 55 that are extended in the Y-axis direction. The linear members 55 are provided below each portion on outsides (sides of the side wall 21 and 22) of the pair of supporting parts 6 in the curtain 5. In this case, the both end parts of the curtain 5 in the X-axis direction are desirably hung on the linear member 55. The linear members 55 are extended over the all length in the Y-axis direction like the supporting part 6 near the shoulder parts 321 and 322 that divide the side walls 21 and 22 and the roof 23 inside the house body 2. The linear members 55 only hold the both end parts of the curtain 5 so as not to hang down the both end parts of the curtain. The linear members 55 do not have functions of supporting the curtain 5. Therefore, each linear member 55 is made of material with low strength, for example, an ester line.

That is, since the pair of supporting parts 6 placed at the both ends in the X-axis direction has hung not the both end parts of the curtain 5 but parts between the central part and the both end parts in the X-axis direction, if there is no linear member 55, the both end parts of the curtain 5 in the X-axis direction hang down by the weight thereof. The linear member 55 prevents the both end parts of the curtain 5 from hanging down by hooking the both end parts of the curtain 5. The curtain 5 moves, while both end parts are worn on the linear member 55 at the time of opening and closing.

Thus, by including the linear member 55, the agricultural house 1 can prevent the both end parts of the curtain 5 from hanging down with easy composition compared with the case where the supporting part 6 and the pulley 71 are added and the both end parts of the curtain 5 are hung. Further, since the linear member 55 is arranged under the curtain 5, even if there is not free space sufficient above the both end parts of the curtain 5, the both end parts of the curtain 5 can be prevented from hanging down. Since the both end parts of the curtain 5 do not hang down, this agricultural house 1 can make small the gaps between the curtain 5 and the side walls 21 and 22 in the full-closed state of the curtain 5, and can suppress the light leak from the gaps.

As shown in FIG. 11, the fastener 56 surrounding the linear member 55 is desirably attached to the both end parts of the curtain 5 in the X-axis direction (width direction). The fastener 56 is formed in ring shape, for example, and attached to the curtain 5 in a state where the linear member 55 is inserted in the fastener 56. The fastener 56 may be formed so that it is possible to prevent the both end parts of the curtain 5 in the X-axis direction from slipping down from the linear member 55, and is not limited to be formed in the ring shape, and may be formed in, for example, a shape surrounding the linear member 55 with the curtain 5.

By including the fastener 56, the agricultural house 1 can avoid that the both end parts of the curtain 5 in the X-axis direction slip down from the linear member 55, and can avoid that the linear member 55 prevents the operation of the opening and closing of the curtain 5 because the linear member 55 raises on the curtain 5. As a result, the agricultural house 1 can realize the smooth opening and closing of the curtain 5.

The other composition and functions are the same as those of the first embodiment. The composition of the present embodiment may be applied in combination with the composition (composition with which the curtain 5 is divided in the Y-axis direction) of the second embodiment.

Incidentally, although the agricultural house 1 in which the fan 241 is provided at each gable wall 24 placed at the both ends of the house body 2 in the Y-axis direction is illustrated in the present embodiment, the agricultural house 1 may include a fun (not shown) that is not only fixed to the regular position but also capable of being moved.

That is, the fan that produces airstream forcibly in the house body 2 is provided inside the house body 2, and the positions in the X-axis direction (or Y-axis direction) and the Z-axis direction are made variable by being supported by an operation mechanism, such as a slide rail (not shown). Therefore, the user can change the position of the fun in the time of operation and the time of non-operation, and; for example, set the fun as the height of 2.1 m or less that is the optimal height in respect of dehumidification of a stock at the time of operation, and can move the fan to the position at which plowing work or weeding work with a tractor at the time of non-operation is prevented. The fun's moving mechanism may be composition that the fan rotates and moves in addition to the composition that the fan moves the fan linearly.

Note that each embodiment described above is an example of the present invention. The present invention is not limited to each embodiment described above, and it should be obvious that, in addition to the above embodiment, various modifications can be made according to the design or the like, as long as they do not depart from the technical idea of the present invention.

1. An agricultural house comprising:
a house body in which a pair of side walls that oppose to each other and a roof connecting upper ends of the pair of side walls are extended in a depth direction; and
a curtain provided along the roof inside the house body,
wherein the curtain is supported by at least one supporting part that is extended in the depth direction, the curtain being configured to be opened and closed along the depth direction.

2. The agricultural house according to claim 1,
wherein the house body comprises a beam that is arranged at both end parts in the depth direction along a plane orthogonal to the depth direction, the beam being configured to support the roof at least, and
wherein the supporting part is fixed to the beam.

3. The agricultural house according to claim 1,
wherein the at least one supporting part comprises three or more supporting parts that are arranged in a width direction that is an opposite direction of the pair of side walls, the three or more supporting parts having different heights in positions at which the three or more supporting parts supports the curtain according to distances from the side walls so that the heights of the curtain is higher as the three or more supporting parts are farthest from the side walls.

4. The agricultural house according to claim 3,
wherein the supporting part is arranged above the curtain, the supporting part being configured to support the curtain by hanging the curtain.

5. The agricultural house according to claim 4,
wherein a pair of supporting parts that are placed at both ends in the width direction among the three or more supporting parts hangs each part between a central part and both end parts of the curtain in the width direction.

6. The agricultural house according to claim 5,
wherein the pair of supporting parts hangs each part closer to the both end parts than the central part of the curtain in the width direction.

7. The agricultural house according to claim 5,
wherein the curtain is provided with a linear member that is extended in the depth direction, the linear member being arranged at each position on sides of the side walls, each position being below than the pair of supporting parts, and
wherein the curtain has both end parts in the width direction, which are hung on the linear member.

8. The agricultural house according to claim 7, wherein the curtain is provided with a fastener that is configured to surround the linear member, the fastener being attached at the both end parts of the curtain in the width direction.

9. The agricultural house according to claim 1, further comprising:
a sensor installed inside the house body, the sensor being configured to detect environment information including temperature at least;
an opening/closing apparatus configured to open and close the curtain, and
a control part configured to control the opening/closing apparatus so that the curtain is opened and closed automatically according to a detection result of the sensor.

10. The agricultural house according to claim 1,
wherein the curtain comprises a core material in each end part in the depth direction, the core material being configured to connect between both ends in the opposite direction of the pair of side walls at least,
the curtain being configured to be opened and closed by the core material moving along the supporting part in the depth direction.

11. The agricultural house according to claim 1, further comprising an opening/closing apparatus configured to open and close the curtain,
wherein the opening/closing apparatus comprises:
a rotating drum configured, by winding a string combined with a free end that is an end of the curtain in the depth direction, to move the free end in the depth direction;
a first pulley in which the string is hung between the rotating drum and the free end, and
a second pulley in which the string is hung between the rotating drum and the first pulley,
wherein the rotating drum and the first pulley are arranged along the roof, and
wherein the second pulley is arranged below the rotating drum and the first pulley.

12. The agricultural house according to claim 11,
wherein the rotating drum and the first pulley are provided with a fence, the fence being provided below the rotating drum and the first pulley so as to surround a circumference of the second pulley and the string, and
wherein the second pulley is fixed to the fence.

13. The agricultural house according to claim 1,
wherein the curtain comprises a plurality of reinforcing bands that have strength more than other parts, the reinforcing bands being extended over both ends in the opposite direction of the pair of side walls, the curtain being supported by the supporting part at the reinforcing bands, and
wherein the plurality of reinforcing bands are provided at predetermined intervals in the depth direction.

14. The agricultural house according to claim 2,
wherein the at least one supporting part comprises three or more supporting parts that are arranged in a width direction that is an opposite direction of the pair of side walls, the three or more supporting parts having different heights in positions at which the three or more supporting parts supports the curtain according to distances from the side walls so that the heights of the curtain is higher as the three or more supporting parts are farthest from the side walls.

15. The agricultural house according to claim 6,
wherein the curtain is provided with a linear member that is extended in the depth direction, the linear member being arranged at each position on sides of the side walls, each position being below than the pair of supporting parts, and
wherein the curtain has both end parts in the width direction, which are hung on the linear member.

16. The agricultural house according to claim 2, further comprising:
a sensor installed inside the house body, the sensor being configured to detect environment information including temperature at least;
an opening/closing apparatus configured to open and close the curtain, and
a control part configured to control the opening/closing apparatus so that the curtain is opened and closed automatically according to a detection result of the sensor.

17. The agricultural house according to claim 2,
wherein the curtain comprises a core material in each end part in the depth direction, the core material being configured to connect between both ends in the opposite direction of the pair of side walls at least,
the curtain being configured to be opened and closed by the core material moving along the supporting part in the depth direction.

18. The agricultural house according to claim 2, further comprising an opening/closing apparatus configured to open and close the curtain,
wherein the opening/closing apparatus comprises:
a rotating drum configured, by winding a string combined with a free end that is an end of the curtain in the depth direction, to move the free end in the depth direction;
a first pulley in which the string is hung between the rotating drum and the free end, and
a second pulley in which the string is hung between the rotating drum and the first pulley,
wherein the rotating drum and the first pulley are arranged along the roof, and
wherein the second pulley is arranged below the rotating drum and the first pulley.

19. The agricultural house according to claim 2,
wherein the curtain comprises a plurality of reinforcing bands that have strength more than other parts, the reinforcing bands being extended over both ends in the opposite direction of the pair of side walls, the curtain being supported by the supporting part at the reinforcing bands, and
wherein the plurality of reinforcing bands are provided at predetermined intervals in the depth direction.
